(19) United States
(12) Patent Application Publication
(10) Pub. No.: US 2026/0038378 A1
(43) Pub. Date: Feb. 5, 2026

(54) AIRCRAFT GROUND ANTI-COLLISION SYSTEM AND METHOD

(71) Applicant: AIRBUS (BEIJING) ENGINEERING CENTRE COMPANY LIMITED, Beijing (CN)

(72) Inventor: Jinming HUANG, Beijing (CN)

(21) Appl. No.: 18/733,396

(22) Filed: Jun. 4, 2024

(30) Foreign Application Priority Data
Jun. 5, 2023 (CN) 202310656088.1

(51) Int. Cl. G08G 5/80; B64D 45/00; G01W 1/02

(52) U.S. Cl. CPC G08G 5/80; B64D 45/00; G01W 1/02

(57) ABSTRACT

An aircraft ground anti-collision system and an aircraft ground anti-collision method are disclosed including an obstacle detecting unit including multiple sensors configured to detect position information of an obstacle around an aircraft; a weather monitoring unit, configured to receive weather information from an information source; and a control unit, configured to receive the position information from the obstacle detecting unit and the weather information from the weather monitoring unit, determine a sensor perception model suitable for the weather information based on the weather information, and set, based on the sensor perception model, a weight of a detection result outputted by each of the sensors in the obstacle detecting unit and output an obstacle detection result.

This application claims the benefit of priority to the following Chinese patent application: Chinese patent application No. 202310656088.1, titled “AIRCRAFT GROUND ANTI-COLLISION SYSTEM AND METHOD”, filed with the China National Intellectual Property Administration on Jun. 5, 2023. Above Chinese patent application is incorporated herein by reference in their entirety.

### FIELD

The present application relates to the field of a ground anti-collision system and method for an aircraft, and, in particular, to a ground anti-collision system and method for an aircraft in which effects of different weather conditions on the accuracy of an obstacle detecting unit are taken into account.

### BACKGROUND

The content in this section only provides background information relating to the present application, which may not constitute conventional technology.

During taxiing and parking on an airport runway and a parking apron, it is necessary for an aircraft to constantly avoid other aircrafts, buildings and other obstacles around the aircraft, in order to prevent collisions. The collisions are particularly likely to occur at a wingtip of the aircraft. Conventional ground collision avoidance solutions for an aircraft mainly rely on two types of technology including automatic dependent surveillance broadcast (ADS-B) and the sensing of surrounding objects by a sensor such as radar and/or a visual sensor. However, each of these two types of technology has some disadvantages.

ADS-B is an aircraft traffic surveillance technology where a position of the aircraft is determined by a satellite navigation system and broadcast periodically, allowing the aircraft to be tracked. An ADS-B scheme is suitable for monitoring a position of a moving aircraft and guiding a route of the aircraft to avoid collisions. However, many ground collision events for aircrafts occur before an ADS-B device is properly enabled, for example, when one aircraft is being towed forward by a trailer while another aircraft remains stationary. On the other hand, the position detection accuracy of the ADS-B scheme is low, with an error that may reach 10 m or more.

In general, the aircraft and airport ground facilities are equipped with a variety of sensors, especially radar and various types of visual sensors (e.g. cameras), in order to detect a position of an obstacle around the aircraft, and to transmit real-time surveillance video image and sensing parameters obtained by analyzing based on the video image to a pilot and ground staff. However, the signal quality of the sensors is greatly affected by the weather, in particular, the image clarity and the accuracy of the parameters of the visual sensor in low light conditions and other adverse weather conditions will be significantly reduced. The effect of the weather on performance of the sensors is not taken into account in conventional anti-collision solutions in which an object around the aircraft is detected based on the visual sensor.

The main advantage of using radar detection solutions over the visual sensor is being less expensive and relatively less affected by light and adverse weather conditions. However, a low spatial resolution is realized for the radar detection technology. In other words, the shape of an object cannot be accurately identified by a radar device. For example, the aircraft can usually be displayed as only a dot or a cross on a surveillance dashboard, and it is not possible to determine precisely the position, shape (e.g. the outline of a wingtip) of the wingtip of the aircraft by the radar. Therefore, it is not possible to accurately avoid collisions between the aircraft and other obstacles by radar detection technology alone. Furthermore, although the accuracy of radar detection is relatively less affected by light and bad weather, these effects should still not be ignored.

In summary, it is still required to develop a reliable ground collision avoidance solution for an aircraft and, in particular, a ground collision avoidance solution for an aircraft in which the safety of the aircraft can still be ensured in adverse weather conditions.

### SUMMARY

It is an object of the present application to provide an improved aircraft ground anti-collision system and method, to improve the accuracy of monitoring ground trajectory and path planning of an aircraft and to improve the safety of ground operations of the aircraft. Another object of the present application is to mitigate the effect of weather factors on the reliability of the aircraft ground anti-collision system and method. It is a further object of the present application to improve the autonomy of the aircraft in adverse weather conditions, so that an obstacle can be reliably avoided even in single-pilot operation.

An aircraft ground anti-collision system is provided according to an aspect of the present application. The aircraft ground anti-collision system includes an obstacle detecting unit, a weather monitoring unit and a control unit. The obstacle detecting unit includes multiple sensors configured to detect position information of an obstacle around an aircraft. The weather monitoring unit is configured to receive weather information from an information source. The control unit is configured to: receive the position information from the obstacle detecting unit and the weather information from the weather monitoring unit, determine, based on the weather information, a sensor perception model suitable for the weather information, and set, based on the sensor perception model, a weight of a detection result outputted by each of the sensors in the obstacle detecting unit and output an obstacle detection result.

In some embodiments, a preset plurality of sensor perception models may be stored in the control unit, and the control unit may be configured to select, based on the weather information, a sensor perception model from the preset plurality of sensor perception models by means of a look-up table.

In some embodiments, an algorithm for building or determining a sensor perception model based on the weather information may be stored in the control unit.

In some embodiments, the aircraft ground anti-collision system may further include a human-machine interface configured to input a pilot instruction to the control unit by a pilot, the control unit may be configured to determine a sensor perception model based on the pilot instruction; and the control unit may be further configured to output the obstacle detection result to the pilot via the human-machine interface.

In some embodiments, the human-machine interface may include an aircraft instrument and/or a head-up display.

In some embodiments, the aircraft ground anti-collision system may be configured to operate in a cooperative mode and/or a non-cooperative mode, where in the cooperative mode, an aircraft equipped with the aircraft ground anti-collision system and a cooperatively communicable obstacle communicate with each other, and the human-machine interface is configured to provide a global view in which a position of the cooperatively communicable obstacle is displayed; where in the non-cooperative mode, the aircraft equipped with the aircraft ground anti-collision system autonomously senses the obstacle around the aircraft, and the human-machine interface is configured to provide a local view in which the obstacle autonomously sensed is displayed.

In some embodiments, the human-machine interface may be configured to automatically display the local view in a case that an obstacle is sensed within a predetermined distance around the aircraft.

In some embodiments, the control unit may be configured to control an operating mode and/or an operating parameter of at least one of the sensors in the obstacle detecting unit based on the sensor perception model.

In some embodiments, the control unit is configured to: in a case that the control unit determines that a weight of a detection result outputted by one or more of the sensors in the obstacle detecting unit under a condition of the sensor perception model is below a predetermined threshold, control the one or more sensors to operate in an enhanced mode.

In some embodiments, the control unit is configured to: after controlling the one or more sensors to operate in the enhanced mode, redetermine the weight of the detection result outputted by the one or more sensors under the condition of the sensor perception model.

In some embodiments, the aircraft ground anti-collision system may further include a risk evaluating unit, where the risk evaluating unit is configured to perform risk evaluation based on the obstacle detection result outputted by the control unit and issue warning information to a pilot based on an evaluated risk level.

In some embodiments, the risk evaluating unit may be configured to: in a case that the risk evaluating unit determines that an automatic driving mode of the aircraft is not suitable for a current weather condition, confirm to the pilot whether to disable the automatic driving mode.

In some embodiments, the multiple sensors in the obstacle detecting unit include at least two of: millimeter wave radar, LiDAR, a conventional camera, an infrared camera, a position sensor, or an ultrasound sensor.

In some embodiments, the information source includes one or more aviation weather information broadcast of: a global forecast system, an automatic terminal information service, a meteorological terminal aviation routine weather report, a special weather report, a terminal aerodrome forecast.

An aircraft ground anti-collision method is provided according to another aspect of the present application. The aircraft ground anti-collision method includes: obtaining weather information; determining a sensor perception model based on the weather information; and setting, based on the sensor perception model, a weight of a detection result outputted by each of sensors in an obstacle detecting unit of an aircraft and outputting an obstacle detection result.

In some embodiments, the aircraft ground anti-collision method may further include: obtaining a pilot instruction, and determining a sensor perception model based on the pilot instruction.

In some embodiments, the aircraft ground anti-collision method may further include: controlling an operating mode and/or an operating parameter of at least one of the sensors in the obstacle detecting unit based on the sensor perception model.

In some embodiments, in a case that it is determined that a weight of a detection result outputted by one or more of the sensors in the obstacle detecting unit under a condition of the sensor perception model is below a predetermined threshold, the one or more sensors may be controlled to operate in an enhanced mode.

In some embodiments, after the one or more sensors are controlled to operate in the enhanced mode, the weight of the detection result outputted by the one or more sensors under the condition of the sensor perception model is redetermined.

In some embodiments, the aircraft ground anti-collision method may further include: displaying, via a human-machine interface, a global view and/or a local view, where a position of a cooperatively communicable obstacle, obtained by the aircraft and the cooperatively communicable obstacle communicating with each other, is displayed in the global view; and an obstacle autonomously sensed by the sensors of the aircraft is displayed in the local view.

In some embodiments, the aircraft ground anti-collision method may further include: automatically displaying the local view in a case that an obstacle is sensed within a predetermined distance around the aircraft.

In some embodiments, the aircraft ground anti-collision method may further include: performing risk evaluation based on the obstacle detection result and issue warning information to a pilot based on an evaluated risk level.

In some embodiments, the aircraft ground anti-collision method may further include: in a process of the risk evaluation, in a case that it is determined that an automatic driving mode of the aircraft is not suitable for a current weather condition, confirming to the pilot whether to disable the automatic driving mode.

In some embodiments, the sensors in the obstacle detecting unit may include at least two of: millimeter wave radar, LiDAR, a conventional camera, an infrared camera, a position sensor, or an ultrasound sensor.

In some embodiments, an information source for obtaining the weather information includes one or more aviation weather information broadcast of: a global forecast system, an automatic terminal information service, a meteorological terminal aviation routine weather report, a special weather report, a terminal aerodrome forecast.

In the aircraft ground anti-collision system and method according to the present application, the effect of weather factors on the sensors (e.g. various types of radar and visual sensors) in the obstacle detecting unit of the aircraft is taken into account, the reliability of each of detection results outputted by the sensors under a current weather condition is evaluated and determined based on the effect of the weather on the sensors, and a corresponding weight is assigned to each of the detection results outputted by the sensors, thereby achieving noise reduction optimization on the output result of the obstacle detecting unit, and improving the reliability and safety of ground collision avoidance for an aircraft.

On the other hand, with the aircraft ground anti-collision system and method according to the present application, the performance of the obstacle detecting unit of the aircraft can also be optimized based on the weather condition, such that the obstacle detecting unit can automatically operate in the enhanced mode with a higher accuracy under adverse weather conditions.

Furthermore, the aircraft ground anti-collision system and method according to the present application does not rely exclusively on cooperative communication between multiple aircrafts for obstacle avoidance, which improves the reliability of the aircraft autonomously detecting an obstacle, thereby facilitating improving the autonomy of operation of the aircraft.

### BRIEF DESCRIPTION OF THE DRAWINGS

Embodiments of the present application will be described below by way of example only, with reference to the accompanying drawings. In the accompanying drawings, the same features or components are represented by the same reference numerals, and the accompanying drawings are not necessarily drawn to scale. In the accompanying drawings:

FIG. 1 illustrates a schematic view of an aircraft ground anti-collision system according to an embodiment of the present application;

FIG. 2 illustrates a schematic view of an aircraft equipped with the aircraft ground anti-collision system in FIG. 1;

FIG. 3 illustrates a flowchart of an aircraft ground anti-collision method according to an embodiment of the present application; and

FIG. 4 illustrates a refined flowchart of step S3 in FIG. 3.

### DETAILED DESCRIPTION OF THE EMBODIMENTS

The following description is by nature exemplary only and is not intended to limit the present application, application and use thereof. It should be understood that in all of these accompanying drawings, similar reference numerals indicate identical or similar parts and features. The drawings merely schematically represent the ideas and principles of embodiments of the present application and do not necessarily show the specific dimensions and the proportions of the embodiments of the present application. Specific parts in specific accompanying drawings may be exaggerated to illustrate related details or structures of various embodiments of the present application.

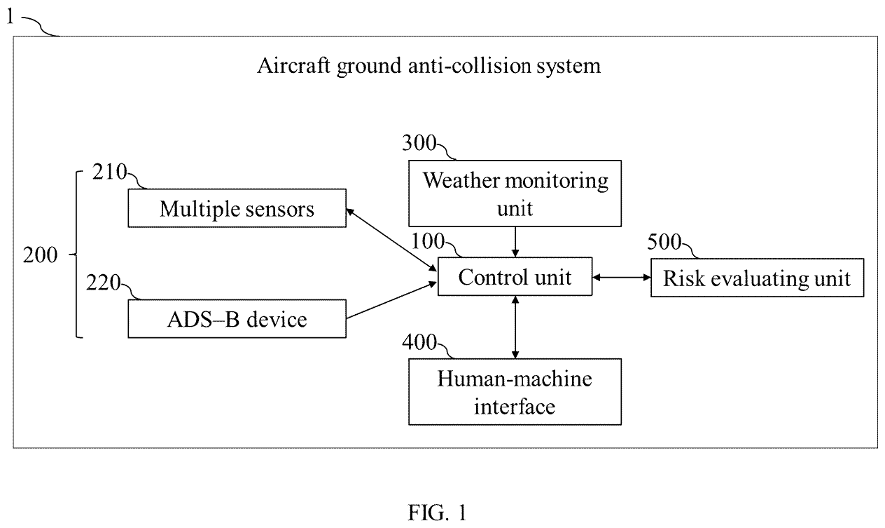

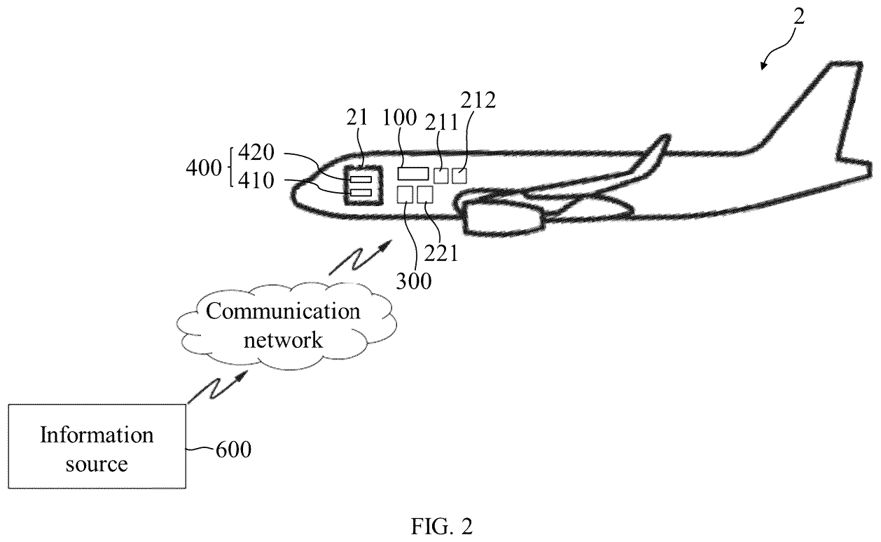

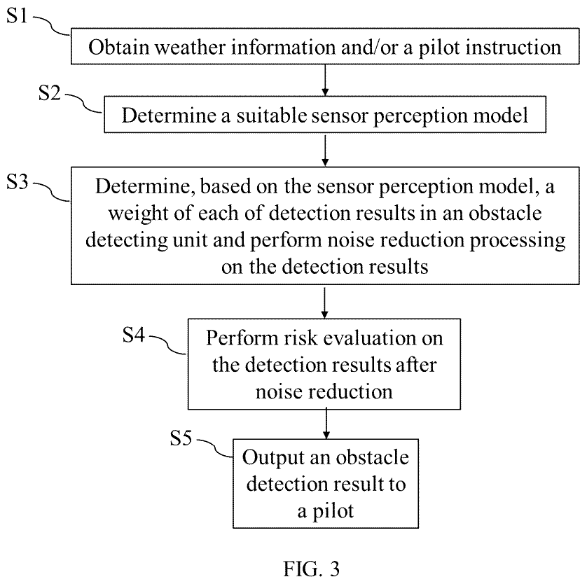

FIG. 1 illustrates a schematic view of an aircraft ground anti-collision system 1 according to an embodiment of the present application; FIG. 2 illustrates a schematic view of an aircraft 2 equipped with the aircraft ground anti-collision system 1 in FIG. 1; and FIG. 3 illustrates a flowchart of an aircraft ground anti-collision method according to an embodiment of the present application.

As shown in FIG. 1, the aircraft ground anti-collision system 1 includes a control unit 100 and an obstacle detecting unit 200. The obstacle detecting unit 200 includes multiple sensors 210 configured to detect position information of an obstacle around the aircraft. The sensors 210 may, for example, be configured to detect position information about an absolute position and/or a relative position of the aircraft with respect to the obstacle, and provide the position information to the control unit 100. The multiple sensors 210 in the obstacle detecting unit 200 may include, but are not limited to, at least two of: millimeter wave radar, LiDAR, a conventional camera, an infrared camera, a stereo camera, a position sensor, an ultrasound sensor, or the like. In addition, the obstacle detecting unit 200 may further include an automatic dependent surveillance broadcast (ADS-B) device 220. As shown in FIG. 2, at least one of the devices, for example, LiDAR 211, a camera 212, an ADS-B receiver 221, in the obstacle detecting unit 200 may be mounted on the aircraft 2. At least one of the devices in the obstacle detecting unit 200 may be mounted outside the aircraft, for example set as a ground facility or an airport on-board facility.

As shown in FIG. 1 and FIG. 2, the aircraft ground anti-collision system 1 may further include a weather monitoring unit 300. The control unit 100 is configured to receive, from the weather monitoring unit 300, information about real-time weather conditions and weather forecasts, for example, weather type, visibility, rainfall/snowfall, or light intensity. The weather monitoring unit 300 may receive the weather information from various information sources 600 via various suitable communication means such as radio communication, cellular communication networks, aeronautical mobile aircraft communication system (AeroMACS). Examples of the information sources include, but are not limited to, various aviation weather information broadcasts such as a global forecast system (GFS), an automatic terminal information service (ATIS), an meteorological terminal aviation routine weather report (METAR), a special weather report (SPECI), a terminal aerodrome forecast (TAF). The information source 600 may for example be set as a ground aviation weather service station.

As shown in FIG. 1 and FIG. 2, the aircraft ground anti-collision system 1 may further include a human-machine interface 400. The human-machine interface 400 may for example be arranged in a cockpit 21 of the aircraft 2. A pilot may input current real-time weather information or other pilot instructions to the control unit 100 via the human-machine interface 400. The weather information or instructions inputted by the pilot may be used for cross-checking, e.g. the priority of the pilot instructions may be set higher than the priority of the weather monitoring unit 300.

As shown in conjunction with FIG. 1 and FIG. 3, multiple sensor perception models suitable for multiple different weather conditions may be stored in the control unit 100 in advance, and the control unit 100 may be configured to: receive the weather information from the weather monitoring unit 300 and/or a pilot instruction from the human-machine interface 400 (step S1), and, based on the received weather information and/or pilot instruction, determine a suitable sensor perception model (step S2). For example, the control unit 100 may select the appropriate sensor perception model from pre-stored multiple sensor perception models by means of a look-up table based on the weather information such as weather type, visibility, rainfall/snowfall, or light intensity. Specifically, the current weather may be classified as sunny, rainy, snowy, hazy or the like based on the weather information, and then a refined sensor perception model appropriate for the current specific weather condition may be searched for under a corresponding weather classification based on quantitative indicators such as visibility, rainfall/snowfall, or light intensity. For example, sensor perception models appropriate for rain conditions may be subdivided into a light rain condition model, a medium rain condition model, a heavy rain condition model, a torrential rain condition model, or the like based on the rainfall. Sensor perception models appropriate for fog conditions may be subdivided into a light fog condition model, a medium fog condition model, a dense fog condition model, or the like, based on the visibility. In other embodiments, it is also possible for the control unit 100 to be configured to store an algorithm for building or determining a suitable sensor perception model based on the weather information obtained from the weather monitoring unit 300 and/or the pilot instruction obtained from the human-machine interface 400. Each sensor perception model records a confidence level of a detection result provided by each of the sensors of the obstacle detecting unit 200 in a corresponding weather condition, whereby the control unit 100 may determine a weight of a detection result provided by each of the sensors in the obstacle detecting unit 200 under the current weather condition (step S3). For example, in adverse weather conditions such as rain, snow, fog, or glare, the control unit 100 may evaluate a detection accuracy error of each of the sensors 210 in the obstacle detecting unit 200 under the current weather condition based on the corresponding sensor perception model. In a case that the detection accuracy error is large or even unacceptably severe, the control unit 100 may reduce the weight of the detection result outputted by the corresponding sensor 210 or even not to use the detection result outputted from the corresponding sensor 210 at all (i.e., the weight is reduced to zero). In other words, the control unit 100 is configured to apply noise reduction to the detection results directly outputted by the obstacle detecting unit 200 based on the determined sensor perception model, thereby reducing the weight of a detection result that is judged to be of low confidence under a condition of the current sensor perception model. As a result, the control unit 100 may output a final obstacle detection result to the pilot e.g. via the human-machine interface 400 (step S5). In addition, the control unit 100 may be configured to plan an anti-collision route for the aircraft based on the final obstacle detection result.

A large number of experimental studies have shown that the effect of different weather conditions on the detection error or confidence of various sensors can be quantified based on indicators such as visibility, rainfall/snowfall, or light intensity. It is possible, for example, to build sensor perception models suitable for various weather conditions based on the results of such experimental studies, and to determine the weight of the detection result of each of sensors in each sensor perception model, in order to exclude, or at least minimize, the adverse effects of weather on the detection result of each of the sensors. For example, in a heavy rain condition model with a rainfall of more than 25 mm/hr, the LiDAR and the various cameras have large detection errors due to being affected by the weather, while the millimeter wave radar and the ultrasound sensor are less affected by the weather and the detection errors are acceptable. Therefore, in this model, the weights of the detection results outputted by the LiDAR and various cameras may be reduced and the weights of the detection results outputted by the millimeter wave radar and the ultrasonic sensor may be increased. For another example, in a dense fog condition model with visibility less than 0.1 km, the LiDAR and conventional cameras are severely affected by the weather, which may cause false detections or detection failures, and therefore the control unit 100 may not use the detection results outputted by the LiDAR and conventional cameras at all in the model, i.e., the weights of the detection results outputted by the LiDAR and the conventional cameras may be reduced to zero.

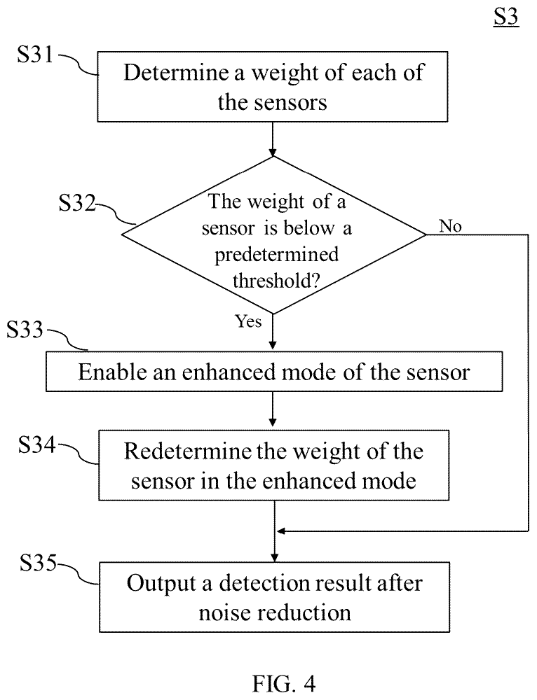

FIG. 4 illustrates a refined flowchart of step S3 in FIG. 3. As shown in FIG. 4, in step S3, the control unit 100 may preferably be further configured to control an operating mode and/or an operating parameter of at least one of the sensors 210 in the obstacle detecting unit 200 based on the weather information obtained from the weather monitoring unit 300 and/or the pilot instruction obtained from the human-machine interface 400, thereby optimizing the performance of the obstacle detecting unit 200. In particular, in a case that the control unit 100 determines that the confidence or weight of the detection results outputted by one or more of the sensors 210 in the obstacle detecting unit 200 under a condition of the currently determined sensor perception model is below a predetermined threshold (steps S31, S32), the control unit 100 controls the one or more sensors to operate in a so-called “enhanced mode” or “high accuracy mode” (step S33), thereby increasing the confidence of the detection result outputted by the sensors in adverse weather conditions. For example, in the heavy rain condition, where the control unit 100 determines that the confidence of the detection result of the LiDAR in the condition is poor, the control unit 100 may control the LiDAR to operate with an operating parameter better suited to the heavy rain condition and may also control the LiDAR to enable a multi-echo verification function and/or a gaze function where the LiDAR is focused on or locked to the detection point of interest (e.g. aircraft wingtip, airport light pole) to improve the accuracy and confidence of the detection result of the LiDAR, especially facilitating the LiDAR recognizing smaller obstacles. In the enhanced mode with the multi-echo verification function and the gaze function being enabled, the accuracy of the detection result of the LiDAR can reach pixel level.

After the control unit 100 controls the one or more sensors 210 in the obstacle detecting unit 200 to operate in the enhanced mode, the control unit 100 may redetermine the confidence and weight of the detection result outputted by each of the sensors operating in the enhanced mode in the current weather condition (step S34), and subsequently output an obstacle detection result after noise reduction based on the redetermined weight (step S35). For example, if the detection result of a sensor originally operating in a normal mode under the current weather condition is judged by the control unit 100 to be too inaccurate to be adopted, but the detection result of the sensor is redetermined by the control unit 100 to be adoptable when the enhanced mode is enabled, the control unit 100 may adopt the detection result of the sensor operating in the enhanced mode based on a corresponding weight.

Referring back to FIG. 1 and FIG. 3, preferably, the aircraft ground anti-collision system 1 may further include a risk evaluating unit 500. The risk evaluating unit 500 may be configured to perform risk evaluation on the aircraft operation based on the obstacle detection result outputted by the control unit 100 (step S4). Subsequently, the step S5 of outputting the obstacle detection result to the pilot may include issuing warning information to the pilot via the human-machine interface 400 based on a risk level evaluated by the risk evaluating unit 500. The warning information provided to the pilot may, for example, be classified into three categories: general information, usually represented in amber, alarm information, usually represented in yellow, and alert information, usually represented in red. In particular, in a case that the risk evaluating unit 500 determines that a safety risk may exist, for example in a case that at least part of the aircraft is too close to an obstacle, if the aircraft is taxiing too fast, if the automatic driving mode of the aircraft is not suitable for the current weather condition, or the like, the risk evaluating unit 500 may confirm to the pilot via the human-machine interface 400 whether to disable the automatic driving mode. Furthermore, since the control unit 100 has performed noise reduction on the detection results of the obstacle detecting unit 200 and/or optimized the performance of the obstacle detecting unit 200 based on the current weather condition, false alarms issued by the risk evaluating unit 500 can be effectively avoided.

The human-machine interface 400 may include various types of displays in the aircraft, in particular in the cockpit, such as an aircraft instrument 410 and/or a head-up display (HUD) 420 schematically illustrated in FIG. 2. The aircraft ground anti-collision system 1 may be configured to be able to provide the pilot with a global view and/or a local view in a cooperative and/or non-cooperative mode, to avoid an aircraft collision event. In the cooperative mode, the human-machine interface 400 displays a global view, in which the position information of a cooperatively communicable obstacle (e.g. other aircrafts or ground service facilities such as towers) around the aircraft may be displayed to the pilot by primarily using the ADS-B device, i.e. collision avoidance is performed through mutual communication between the aircraft and the obstacle. The global view is for example suitable for displaying the obstacle in a larger area around the aircraft (e.g. within a diameter of 2 to 3 km at the center of the aircraft). In the non-cooperative mode, the human-machine interface 400 displays the local view, in which the obstacle around the aircraft autonomously sensed primarily by the sensors on the aircraft equipped with the aircraft ground anti-collision system 1 according to the present application may be displayed to the pilot. The local view is suitable, for example, for displaying the obstacle in a smaller area around the aircraft (e.g. within a diameter of 100 to 500 m at the center of the aircraft). The human-machine interface 400 may be configured to automatically display the local view in a case that an obstacle is sensed within a predetermined distance (e.g. within 150 m) around the aircraft to improve the pilot's awareness of the scenario, which increases autonomy in the operation of the aircraft and the ability to reliably avoid the obstacle even in single-pilot operation situations, thereby improving the robustness and certainty of the system. It should be noted that the human-machine interface 400 may be configured to provide the pilot with both the global view and the local view at the same time, to facilitate the pilot fully understanding the obstacle situation around the aircraft.

The effect of different weather conditions on the detection accuracy of various radar, visual sensors and other obstacle sensors commonly used on the aircraft is objective and unavoidable. With the aircraft ground anti-collision system and method according to the present application, a suitable sensor perception model is determined based on, for example, the weather condition obtained from aerial meteorological information, and the reliability of the detection result of each of the various sensors is accordingly evaluated, and a corresponding weight is assigned to each of the detection results outputted by the sensors, thereby achieving noise reduction optimization on the output result of the obstacle detecting unit, and improving the reliability and safety of the aircraft ground anti-collision system.

Furthermore, with the aircraft ground anti-collision system and method according to the present application, the performance of the obstacle detecting unit of the aircraft can also be optimized based on the weather condition, such that the obstacle detecting unit can automatically operate in the enhanced mode with a higher accuracy under adverse weather conditions.

Furthermore, the aircraft ground anti-collision system and method according to the present application does not rely exclusively on cooperative communication between multiple aircrafts for obstacle avoidance, the pilot can be provided with the global view in the cooperative mode and/or the local view in the non-cooperative mode, which improves the reliability of autonomously detecting the obstacle by the aircraft, thereby facilitating improving the autonomy of operation of the aircraft and the pilot's awareness of the scenario.

Herein, exemplary embodiments of the aircraft ground anti-collision system and method according to the present application have been described in detail, but it should be understood that the present application is not limited to the specific embodiments described and illustrated in detail above. Various modifications and variations can be made by those skilled in the art to the present application, without departing from the spirit and scope of the present application. All the variations and modifications shall fall within the scope of the present application. Moreover, all the components described herein can be replaced by other technically equivalent components.

1. An aircraft ground anti-collision system, comprising:
an obstacle detecting unit, comprising a plurality of sensors configured to detect position information of an obstacle around an aircraft;
a weather monitoring unit, configured to receive weather information from an information source; and
a control unit, configured to: receive the position information from the obstacle detecting unit and the weather information from the weather monitoring unit, determine, based on the weather information, a sensor perception model suitable for the weather information, and set, based on the sensor perception model, a weight of a detection result outputted by each of the sensors in the obstacle detecting unit and output an obstacle detection result.

2. The aircraft ground anti-collision system according to claim 1, wherein
a preset plurality of sensor perception models is stored in the control unit, and the control unit is configured to select, based on the weather information, a sensor perception model from the preset plurality of sensor perception models by means of a look-up table; or
an algorithm for building or determining a sensor perception model based on the weather information is stored in the control unit.

3. The aircraft ground anti-collision system according to claim 1, wherein the aircraft ground anti-collision system further comprises a human-machine interface configured to input a pilot instruction to the control unit by a pilot, the control unit is configured to determine a sensor perception model based on the pilot instruction; and the control unit is further configured to output the obstacle detection result to the pilot via the human-machine interface.

4. The aircraft ground anti-collision system according to claim 3, wherein the human-machine interface comprises an aircraft instrument and/or a head-up display.

5. The aircraft ground anti-collision system according to claim 3, wherein the aircraft ground anti-collision system is configured to operate in a cooperative mode and/or a non-cooperative mode, wherein in the cooperative mode, an aircraft equipped with the aircraft ground anti-collision system and a cooperatively communicable obstacle communicate with each other, and the human-machine interface is configured to provide a global view in which a position of the cooperatively communicable obstacle is displayed; wherein in the non-cooperative mode, the aircraft equipped with the aircraft ground anti-collision system autonomously senses an obstacle around the aircraft, and the human-machine interface is configured to provide a local view in which the obstacle autonomously sensed is displayed.

6. The aircraft ground anti-collision system according to claim 5, wherein the human-machine interface is configured to automatically display the local view in a case that an obstacle is sensed within a predetermined distance around the aircraft.

7. The aircraft ground anti-collision system according to claim 1, wherein the control unit is configured to control an operating mode and/or an operating parameter of at least one of the sensors in the obstacle detecting unit based on the determined sensor perception model.

8. The aircraft ground anti-collision system according to claim 7, wherein the control unit is configured to: in a case that the control unit determines that a weight of a detection result outputted by one or more of the sensors in the obstacle detecting unit under a condition of the determined sensor perception model is below a predetermined threshold, control the one or more sensors to operate in an enhanced mode.

9. The aircraft ground anti-collision system according to claim 8, wherein, the control unit is configured to: after controlling the one or more sensors to operate in the enhanced mode, redetermine the weight of the detection result outputted by the one or more sensors under the condition of the determined sensor perception model.

10. The aircraft ground anti-collision system according to claim 1, wherein the aircraft ground anti-collision system further comprises a risk evaluating unit, wherein the risk evaluating unit is configured to perform risk evaluation based on the obstacle detection result outputted by the control unit and issue warning information to a pilot based on an evaluated risk level.

11. The aircraft ground anti-collision system according to claim 10, wherein the risk evaluating unit is configured to: in a case that the risk evaluating unit determines that an automatic driving mode of the aircraft is not suitable for a current weather condition, confirm to the pilot whether to disable the automatic driving mode.

12. The aircraft ground anti-collision system according to claim 1, wherein the plurality of sensors in the obstacle detecting unit comprises at least two of: millimeter wave radar, LiDAR, a conventional camera, an infrared camera, a position sensor, or an ultrasound sensor, and/or
wherein the information source comprises one or more aviation weather information broadcast of: a global forecast system, an automatic terminal information service, a meteorological terminal aviation routine weather report, a special weather report, a terminal aerodrome forecast.

13. An aircraft ground anti-collision method, comprising:
obtaining weather information;
determining a sensor perception model based on the weather information; and
setting, based on the sensor perception model, a weight of a detection result outputted by each of sensors in an obstacle detecting unit of an aircraft and outputting an obstacle detection result.

14. The aircraft ground anti-collision method according to claim 13, further comprising:
obtaining a pilot instruction, and determining a sensor perception model based on the pilot instruction.

15. The aircraft ground anti-collision method according to claim 13, further comprising:
controlling an operating mode and/or an operating parameter of at least one of the sensors in the obstacle detecting unit based on the sensor perception model.

16. The aircraft ground anti-collision method according to claim 15, wherein, in a case that it is determined that a weight of a detection result outputted by one or more of the sensors in the obstacle detecting unit under a condition of the sensor perception model is below a predetermined threshold, the one or more sensors are controlled to operate in an enhanced mode.

17. The aircraft ground anti-collision method according to claim 16, wherein, after the one or more sensors are controlled to operate in the enhanced mode, the weight of the detection result outputted by the one or more sensors under the condition of the sensor perception model is redetermined.

18. The aircraft ground anti-collision method according to claim 13, further comprising:
displaying, via a human-machine interface, a global view and/or a local view, wherein a position of a cooperatively communicable obstacle, obtained by the aircraft and the cooperatively communicable obstacle communicating with each other, is displayed in the global view; and an obstacle autonomously sensed by the sensors of the aircraft is displayed in the local view, and
automatically displaying the local view in a case that an obstacle is sensed within a predetermined distance around the aircraft.

19. The aircraft ground anti-collision method according to claim 13, further comprising:
performing risk evaluation based on the obstacle detection result and issue warning information to a pilot based on an evaluated risk level, and
in a process of the risk evaluation, in a case that it is determined that an automatic driving mode of the aircraft is not suitable for a current weather condition, confirming to the pilot whether to disable the automatic driving mode.

20. The aircraft ground anti-collision method according to claim 13, wherein the sensors in the obstacle detecting unit comprise at least two of: millimeter wave radar, LiDAR, a conventional camera, an infrared camera, a position sensor, or an ultrasound sensor, and/or
wherein an information source for obtaining the weather information comprises one or more aviation weather information broadcast of: a global forecast system, an automatic terminal information service, a meteorological terminal aviation routine weather report, a special weather report, a terminal aerodrome forecast.
